(19) United States
(12) Patent Application Publication
(10) Pub. No.: US 2018/0224336 A1
(43) Pub. Date: Aug. 9, 2018

(54) TEMPERATURE SENSOR AND POSITION DETECTION DEVICE

(71) Applicant: ALPS ELECTRIC CO., LTD., Tokyo (JP)

(72) Inventors: Taiji SUGAWARA, Miyagi-Ken (JP); Kyozo SAITO, Miyagi-Ken (JP)

(21) Appl. No.: 15/942,879

(22) Filed: Apr. 2, 2018

Related U.S. Application Data
(63) Continuation of application No. PCT/JP2016/079550, filed on Oct. 4, 2016.

(30) Foreign Application Priority Data
Nov. 12, 2015 (JP) 2015-222110

(51) Int. Cl. G01K 1/12; G01K 7/24; G01D 5/12

(52) U.S. Cl. CPC G01K 1/12; G01D 5/12; G01K 7/24

(57) ABSTRACT

A temperature sensor includes a case including a body portion and a tubular portion projecting outward from the body portion, the tubular portion being formed in a tubular shape closed at a side defining a tip, a temperature sensor element arranged within the tubular portion at the tip, a wire member connected to the temperature sensor element, a retaining portion disposed within the tubular portion at a position closer to the body portion than the temperature sensor element, the retaining portion being filled with a retaining material to support the wire member, and a heat insulating section disposed between the temperature sensor element and the retaining portion, the heat insulating section including a heat insulating member made of a less heat-transferable material than the retaining material.

### CLAIM OF PRIORITY

This application is a Continuation of International Application No. PCT/JP2016/079550 filed on Oct. 4, 2016, which claims benefit of Japanese Patent Application No. 2015-222110 filed on Nov. 12, 2015. The entire contents of each application noted above are hereby incorporated by reference.

### BACKGROUND OF THE INVENTION

### 1. Field of the Invention

The present invention relates to a temperature sensor for measuring a temperature of a fluid, such as air taken into an engine, and to a position detection device including the temperature sensor.

### 2. Description of the Related Art

Recently, temperature sensors have been used in various types of control in a vehicle. The temperature sensor includes a temperature sensor element coated with glass, for example, and has a structure that the temperature sensor element is arranged in a tip portion of a tip-closed tube for protection purposes. A tip of the temperature sensor element is held in direct contact with the tube to increase efficiency of heat transfer to the temperature sensor element. However, detection accuracy of the temperature sensor element degrades if heat dissipates. One solution conceivable to cope with the above problem is a method of avoiding dissipation of heat to be transferred to the temperature sensor element by providing, for example, an air layer inside the tube at a position except for the tip portion.

Japanese Unexamined Patent Application Publication No. 2012-42451 discloses an example of a structure including the air layer as described above. FIG. 8 is a sectional view of a temperature sensor 900 disclosed in Japanese Unexamined Patent Application Publication No. 2012-42451. As illustrated in FIG. 8, a temperature sensor element 921 is arranged inside a tube 911 at a tip 912. In the disclosed structure, a back end 945 of a glass tube 941 is pushed toward the tip side by utilizing deformation that is generated in a sealing member 971. As a result, the temperature sensor element 921 arranged at the tip side is pressed against the tip 912 of the tube 911 from the inside.

However, the above-described related art has a problem that a sensor structure is complicated because of the necessity of the structure for biasing the glass tube 941 toward the tip side by the sealing member 971. Thus, there has been a demand for a structure capable of preventing dissipation of heat to be transferred to the temperature sensor with a simpler configuration.

### SUMMARY OF THE INVENTION

With intent to solve the above-described problem, the present invention provides a temperature sensor having higher temperature sensing performance with a simpler configuration, and a position detection device including the temperature sensor.

The present invention provides a temperature sensor including a case that includes a body portion and a tubular portion projecting outward from the body portion, the tubular portion being formed in a tubular shape closed at a side defining a tip, a temperature sensor element arranged within the tubular portion at the tip, a wire member connected to the temperature sensor element, a retaining portion disposed within the tubular portion at a position closer to the body portion than the temperature sensor element, the retaining portion being filled with a retaining material to support the wire member, and a heat insulating section disposed between the temperature sensor element and the retaining portion, the heat insulating section including a heat insulating member made of a less heat-transferable material than the retaining material.

With the above features, since the heat insulating section is disposed between the temperature sensor element and the retaining portion, a structure in which heat is less dissipated from the temperature sensor element can be obtained. Accordingly, the temperature sensor having higher temperature sensing performance can be obtained with a simpler configuration.

In the temperature sensor according to the present invention, preferably, the heat insulating member in the heat insulating section is arranged in a state fixed to the wire member at a position near the temperature sensor element.

With the above feature, since the heat insulating member is arranged in the state fixed to the wire member, the temperature sensor element is pushed toward the tip of the tubular portion with the heat insulating member interposed therebetween when the retaining material is filled. As a result, the temperature sensor element can be pressed against the tip of the tubular portion without providing any biasing mechanism. Hence the temperature sensing performance is improved.

In the temperature sensor according to the present invention, preferably, the heat insulating member is made of foam polystyrene or a phenol resin.

With the above feature, the heat insulating member can be easily arranged in place.

In the temperature sensor according to the present invention, preferably, the heat insulating section includes gas kept between the heat insulating member and the temperature sensor element.

With the above feature, thermal insulation is further enhanced by utilizing, as part of the heat insulating section, the gas that is less heat-transferable.

The present invention further provides a position detection device including position detection means configured to detect a position of a detection object, and temperature sensing means configured to sense an ambient temperature around the detection object, wherein the temperature sensing means includes the above-described temperature sensor.

With the above features, the position detection device equipped with the temperature sensor having higher temperature sensing performance can be obtained. Thus, control depending on the position of the detection object can be more appropriately performed by sensing the ambient temperature around the detection object to be detected by the position detection means.

### BRIEF DESCRIPTION OF THE DRAWINGS

FIG. 1 is a sectional view of a temperature sensor according to a first embodiment of the present invention;

FIGS. 2A and 2B are external views of a heat insulating member; specifically, FIG. 2A is a plan view, and FIG. 2B is a front view;

FIG. 3 is a sectional view illustrating a state in which a holder, the heat insulating member, and a substrate are fixed to a wire member that is connected to a temperature sensor element;

FIG. 4 is a sectional view of a case in a state before attaching a cap;

FIG. 5 is a sectional view illustrating a state in which the temperature sensor element is inserted into a tubular portion of the case;

FIG. 6 is a sectional view illustrating a state in which a retaining material is filled;

FIG. 7 is a block diagram of a position detection device according to a second embodiment of the present invention; and

FIG. 8 is a sectional view of a temperature sensor of related art.

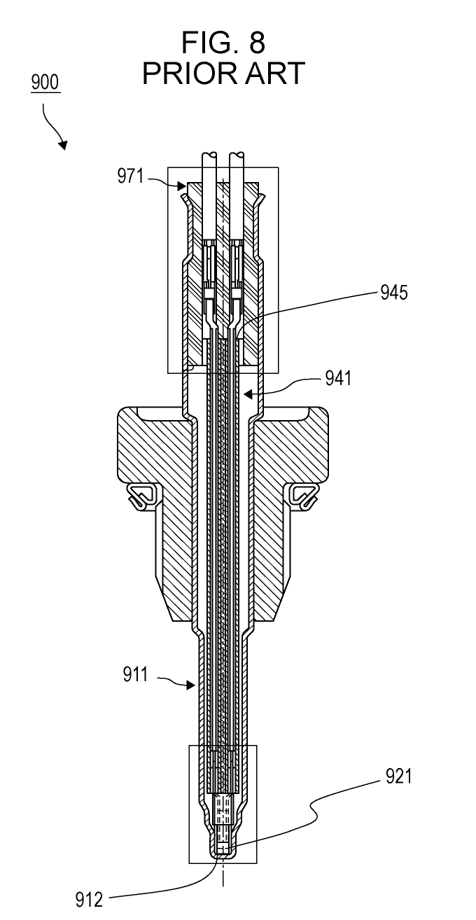

### DESCRIPTION OF THE PREFERRED EMBODIMENTS

Embodiments of the present invention will be described in detail below with reference to the drawings. It is to be noted that dimensions of components in the drawings are changed as appropriate for easier understanding.

### First Embodiment

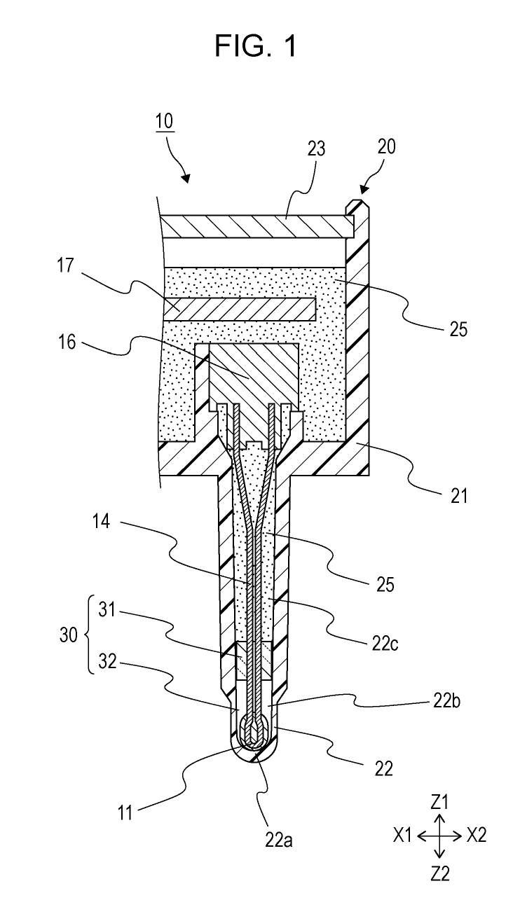

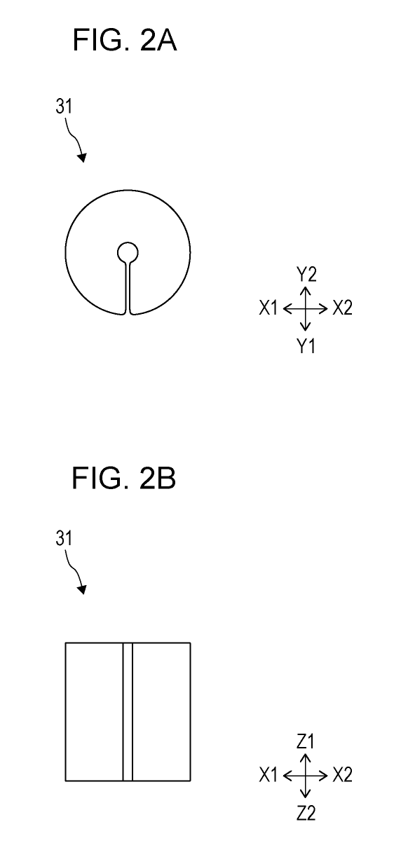

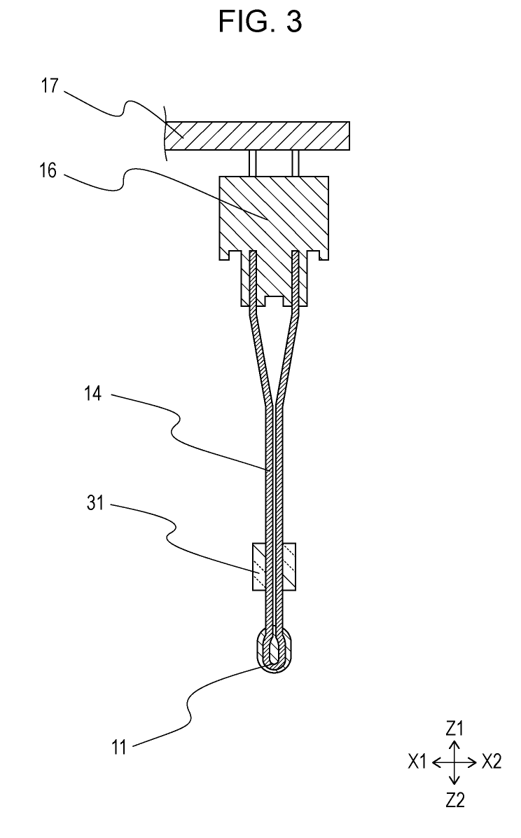

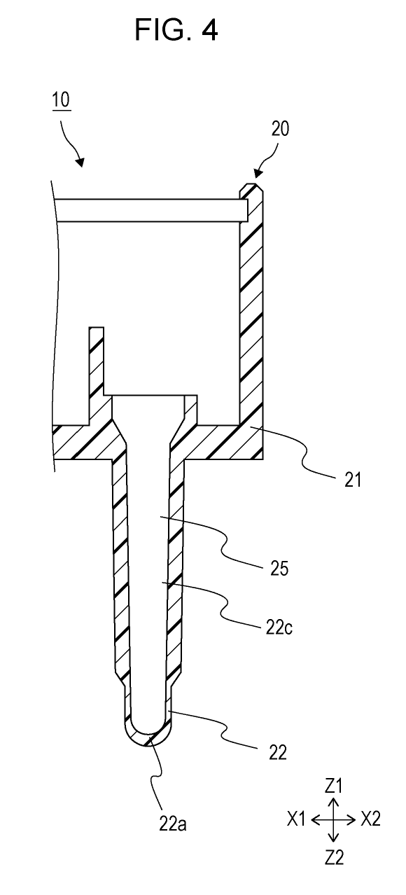

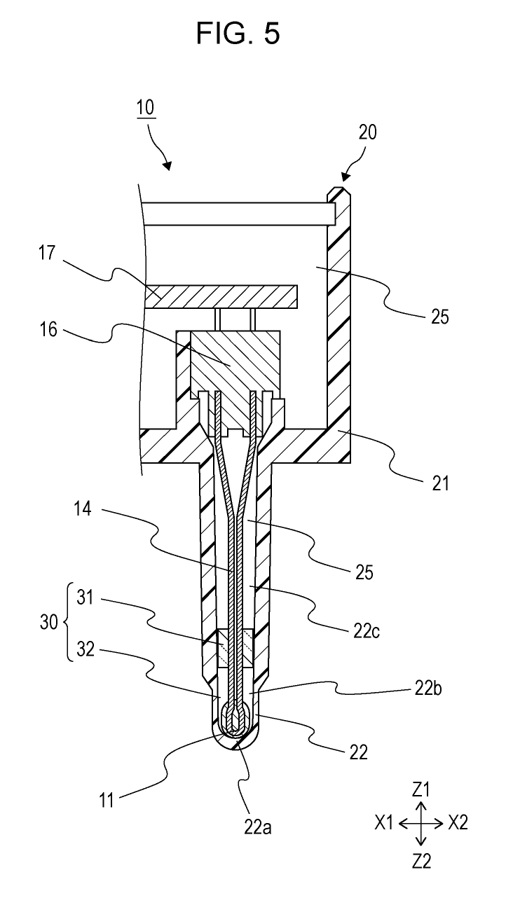

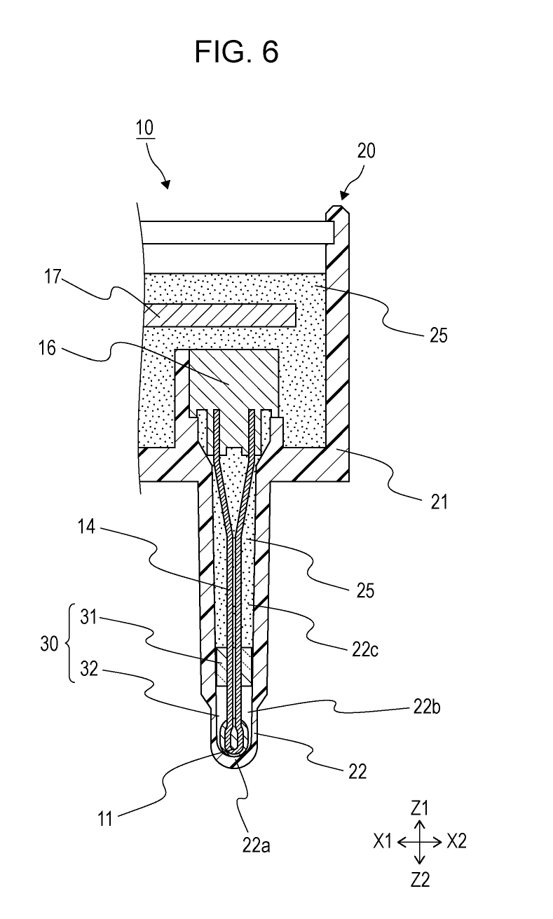

FIG. 1 is a sectional view of a temperature sensor 10 according to a first embodiment of the present invention. FIGS. 2A and 2B are external views of a heat insulating member 31; specifically, FIG. 2A is a plan view, and FIG. 2B is a front view. FIG. 3 is a sectional view illustrating a state in which a holder 16, the heat insulating member 31, and a substrate 17 are fixed to a wire member 14 that is connected to a temperature sensor element 11. FIG. 4 is a sectional view of a case 20 in a state before attaching a cap 23. FIG. 5 is a sectional view illustrating a state in which the temperature sensor element 11 is inserted into a tubular portion 22 of the case 20. FIG. 6 is a sectional view illustrating a state in which a retaining material 25 is filled.

The temperature sensor 10 according to the first embodiment of the present invention includes the temperature sensor element 11 accommodated in the case 20, and it is constituted as illustrated in the sectional view of FIG. 1.

The case 20 is molded of a synthetic resin material, and includes a box-shaped body portion 21 having an open surface, the tubular portion 22 projecting outward (in a direction denoted by Z2 in FIG. 1) from the body portion 21 and being formed in a tubular shape closed at the side defining a tip 22a, and the cap 23 closing the open surface of the body portion 21.

The temperature sensor element 11 changes an electrical output depending on temperature, and enables an ambient temperature to be measured from a value of the electrical output. The temperature sensor element 11 in this embodiment is formed by using a Thermistor that is a resistor exhibiting a great change in electrical resistance with respect to a temperature change. The wire member 14 connected to the temperature sensor element 11 is fixed to the holder 16 and is electrically connected to a not-illustrated wiring portion of the substrate 17. Furthermore, the heat insulating member 31 is attached to the wire member 14.

As illustrated in FIG. 1, the retaining material 25 is filled into a gap between the wire member 14 and the tubular portion 22, and a gap between each of the holder 16 and the substrate 17 and the body portion 21. The retaining material 25 used in this embodiment is a one-component epoxy resin and has thermal conductivity of 0.3 [W/(m·K)] at 20° C. A predetermined amount of the retaining material 25 is filled in a liquefied state and then cured by heat treatment. The temperature sensor 10 according to this embodiment further includes, between the heat insulating member 31 and the temperature sensor element 11, a gap portion 22b where the retaining material 25 is not filled and gas 32 remains. The gas 32 in this embodiment is air, and the thermal conductivity of air at 20° C. is 0.024 [W/(m·K)].

The heat insulating member 31 is preferably made of a material having physical properties being less heat-transferable than the retaining material 25. The heat insulating member 31 used in this embodiment may be made of foam polystyrene that is less heat-transferable than the retaining material 25, and that has no fluidity. While the thermal conductivity of the retaining material 25 at 20° C. is 0.3 [W/(m·K)], the thermal conductivity of the heat insulating member 31 at 20° C. is 0.03 [W/(m·K)]. As illustrated in FIGS. 2A and 2B, the heat insulating member 31 has a column-like shape in external view and includes a cut formed to extend from a lateral surface toward a center with a hole penetrating through a central portion. Thus, the heat insulating member 31 is elastically deformable, and it can be attached to the wire member 14 in a state fixed thereto.

The temperature sensor element 11 is pressed against the tip 22a of the tubular portion 22 of the case 20. Therefore, heat transfer between the tip 22a and the temperature sensor element 11 is improved, and an ambient temperature around the tip 22a of the tubular portion 22 can be measured with higher accuracy. Furthermore, both the heat insulating member 31 being less heat-transferable than the retaining material 25 and the gas 32 kept in the gap portion 22b between the heat insulating member 31 and the temperature sensor element 11 function as a heat insulating section 30 and suppresses heat transfer toward the body portion 21. Accordingly, when the ambient temperature around the tip 22a of the tubular portion 22 is changed, the temperature sensor element 11 can operate more promptly in response to the temperature change with higher thermal responsivity.

The temperature sensor 10 according to this embodiment can be manufactured through steps illustrated in FIGS. 3 to 6, for example.

As illustrated in FIG. 3, the wire member 14 connected to the temperature sensor element 11 is fixed to the holder 16. The heat insulating member 31 is fixed to the wire member 14 at a position near the temperature sensor element 11. Furthermore, the wire member 14 is electrically connected to the substrate 17. Although the cut is formed in the heat insulating member 31 in this embodiment to reduce a gap between the heat insulating member 31 and the wire member 14, the heat insulating member 31 may be fixed to the wire member 14 by using an adhesive or the like. In the latter case, even when the gap is somewhat large, the gap can be closed with the adhesive or the like. When the gap is closed with the adhesive or the like, the heat insulating member 31 can be formed by using any types of materials having physical properties being less heat-transferable without being limited to the material that is susceptible to elastic deformation. For example, a relatively hard phenol resin can also be used.

As illustrated in FIG. 4, the case 20 is prepared in a state before attaching the cap 23. Then, as illustrated in FIG. 5, the temperature sensor element 11 is inserted into the tubular portion 22 to be arranged at the tip 22a. In this connection, the external shape of the heat insulating member 31 is designed to form a small gap relative to an inner wall of the tubular portion 22, and hence not to impede the temperature sensor element 11 from being fully pushed in up to the tip 22a. Although the holder 16 comes into contact with the body portion 21, the temperature sensor element 11 can be brought into a positively pushed-in state for the reason that the wire member 14 is prepared in a slightly longer length and is flexed when the temperature sensor element 11 is pushed in up to the tip 22a.

Next, as illustrated in FIG. 6, under a condition of holding the temperature sensor 10 with the Z2 direction facing downward, the retaining material 25 is filled in the liquefied state into the gap between the wire member 14 and the tubular portion 22, and the gap between each of the holder 16 and the substrate 17 and the body portion 21. At that time, since the heat insulating member 31 is arranged in advance, the gap portion 22b where the retaining material 25 is not filled is formed between the heat insulating member 31 and the temperature sensor element 11 due to the action of surface tension, and the atmosphere remaining in the gap portion 22b is kept as the gas 32. Moreover, since the heat insulating member 31 is arranged in the state fixed to the wire member 14, the temperature sensor element 11 is pushed toward the tip 22a of the tubular portion 22 with the heat insulating member 31 interposed therebetween when the retaining material 25 is filled. As a result, the temperature sensor element 11 can be pressed against the tip 22a of the tubular portion 22 without providing any biasing mechanism. In order to make the temperature sensor element 11 positively fixed to the tip 22a, the retaining material 25 may be previously coated over an end portion of the temperature sensor element 11.

Thereafter, the retaining material 25 is cured by heat treatment, thus resulting in a state that the retaining material 25 retains the wire member 14. Finally, the cap 23 is attached to the case 20.

Since the heat insulating section 30 is disposed between the temperature sensor element 11 and a retaining portion 22c, a structure in which heat is less dissipated from the temperature sensor element 11 can be obtained.

Advantageous effects obtained with this embodiment will be described below.

The temperature sensor 10 according to this embodiment includes the case 20, the temperature sensor element 11, and the wire member 14 connected to the temperature sensor element 11. The case 20 includes the body portion 21, and the tubular portion 22 projecting outward from the body portion 21 and formed in the tubular shape closed at the side defining the tip 22a. The temperature sensor element 11 is arranged within the tubular portion 22 at the tip 22a. The retaining portion 22c, which is filled with the retaining material 25 to support the wire member 14, is disposed within the tubular portion 22 at a position closer to the body portion 21 than the temperature sensor element 11. In addition, the heat insulating section 30 including the heat insulating member 31 being less heat-transferable than the retaining material 25 is disposed between the temperature sensor element 11 and the retaining portion 22c.

With the features described above, since the provision of the heat insulating section 30 between the temperature sensor element 11 and the retaining portion 22c gives the structure in which heat is less dissipated from the temperature sensor element 11, the temperature sensor 10 having higher temperature sensing performance can be obtained with a simpler configuration.

In the temperature sensor 10 according to this embodiment, the heat insulating section 30 is preferably constituted such that the heat insulating member 31 is arranged in the state fixed to the wire member 14 at a position near the temperature sensor element 11.

With the feature described above, since the heat insulating member 31 is arranged in the state fixed to the wire member 14, the temperature sensor element 11 is pushed toward the tip 22a of the tubular portion 22 with the heat insulating member 31 interposed therebetween when the retaining material 25 is filled. As a result, the temperature sensor element 11 can be pressed against the tip 22a of the tubular portion 22 without arranging any biasing mechanism. Hence the temperature sensing performance is improved.

Furthermore, in the temperature sensor 10 according to this embodiment, the heat insulating member 31 may be made of foam polystyrene or a phenol resin. While the thermal conductivity of the retaining material 25 at 20° C. is 0.3 [W/(m·K)], the thermal conductivity of the heat insulating member 31 is 0.03 [W/(m·K)] in the case of using foam polystyrene or a phenol resin and 0.13 to 0.25 [W/(m·K)] in the case of using a phenol resin. With the feature described above, since the heat insulating member is made of the material being less heat-transferable than the retaining material 25 and having no fluidity, the heat insulating member can be easily arranged in place.

Moreover, in the temperature sensor 10 according to this embodiment, the heat insulating section 30 includes the heat insulating member 31 and the gas 32 kept between the heat insulating member 31 and the temperature sensor element 11. With the feature described above, thermal insulation is further enhanced by utilizing, as part of the heat insulating section 30, the gas that is less heat-transferable.

### Second Embodiment

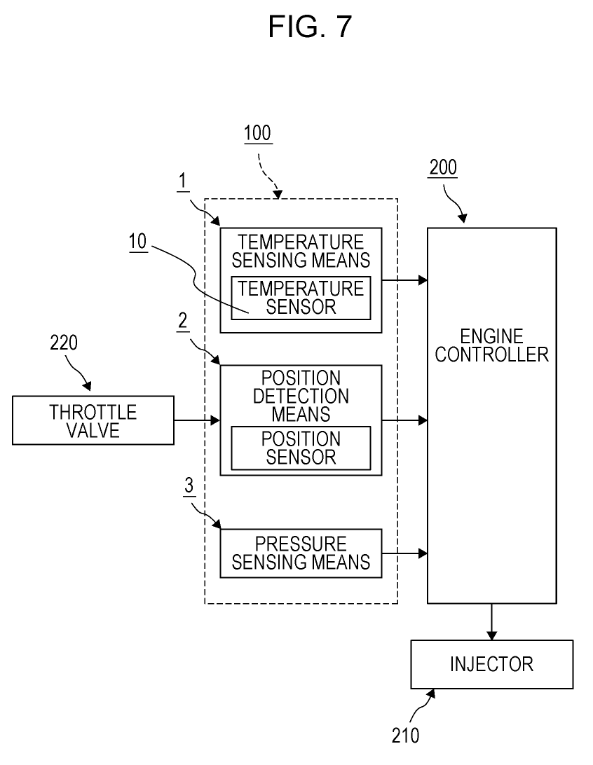

FIG. 7 is a block diagram of a position detection device 100 according to a second embodiment of the present invention.

As illustrated in FIG. 7, the position detection device 100 according to this embodiment represents an example in which the position detection device 100 is attached to a throttle valve 220 for controlling an engine output. It is to be noted that the position detection device 100 can be used in various applications without being limited to such an example.

The position detection device 100 illustrated in FIG. 7 includes position detection means 2 configured to detect a position of a detection object, temperature sensing means 1 configured to sense an ambient temperature around the detection object, and pressure sensing means 3 configured to sense a pressure of taken-in gas (atmosphere). The temperature sensing means 1 includes the temperature sensor 10 according to the first embodiment.

The position detection means 2 detects the position of the detection object that is moved in conjunction with a rotation shaft for adjusting an opening degree of the throttle valve 220. More specifically, the position detection means 2 is constituted by using a variable resistor exhibiting a resistance value that is changed with sliding of a movable contact over a resistive element, the movable contact being moved depending on the position of the detection object, or using a magnetic sensor for sensing magnetic force of a magnet that is moved depending on the position of the detection object. A method of sensing a rotation angle in conjunction with the rotation shaft of the throttle valve 220, or a method of detecting a position through mechanical conversion to a linear movement can be used, for example.

A pressure sensor, for example, can be used as the pressure sensing means 3.

Output values of the position detection means 2 and the pressure sensing means 3 are transmitted to an engine controller 200, and an amount of fuel injected from an injector 210 is optimized by the engine controller 200.

In the position detection device 100, the case 20 in the first embodiment is used as a case common to the position detection means 2 and the pressure sensing means 3 as well such that the temperature sensing means 1, the position detection means 2, and the pressure sensing means 3 can be assembled into an integral unit. It is therefore possible to detect the ambient temperature around the detection object to be detected by the position detection means 2 at a close position with the small-sized device. Thus, the amount of fuel injected from the injector 210 can be more appropriately controlled depending on the position of the detection object. As a result, exhaust gas from an engine can be made cleaner.

Advantageous effects obtained with this embodiment will be described below.

The position detection device 100 according to this embodiment is featured in that the device includes the position detection means 2 configured to detect the position of the detection object, and the temperature sensing means 1 configured to sense the ambient temperature around the detection object, and that the temperature sensing means 1 includes the above-described temperature sensor 10.

With the features described above, control depending on the position of the detection object can be more appropriately performed by sensing the ambient temperature around the detection object to be detected by the position detection means 2.

While the temperature sensor 10 according to the first embodiment of the present invention and the position detection device 100 according to the second have been described above, the present invention is not limited to the above embodiments and can be implemented in various modified ways insofar as not departing from the gist of the invention. The present invention may be modified, by way of example, as follows. The following modifications also fall within the technical scope of the present invention.

(1) While, in the embodiment, the Thermistor is used as the temperature sensor element 11, a thermocouple may be used instead.

(2) While, in the embodiment, the tubular portion 22 of the case 20 is integrally formed of a synthetic resin material, a portion including the tip 22a may be formed of a composite material by using a material having higher thermal conductivity. Higher thermal responsivity can be obtained in the latter case.

(3) While, in the embodiment, the heat insulating section 30 includes the gas 32 kept between the heat insulating member 31 and the temperature sensor element 11, the heat insulating member 31 and the temperature sensor element 11 may be arranged in contact with each other when the performance of the heat insulating member 31 is sufficient.

What is claimed is:

1. A temperature sensor comprising:
a case including a body portion and a tubular portion projecting outward from the body portion, the tubular portion being formed in a tubular shape closed at a side defining a tip;
a temperature sensor element arranged within the tubular portion at the tip;
a wire member connected to the temperature sensor element;
a retaining portion disposed within the tubular portion at a position closer to the body portion than the temperature sensor element, the retaining portion being filled with a retaining material to support the wire member; and
a heat insulating section disposed between the temperature sensor element and the retaining portion, the heat insulating section including a heat insulating member made of a less heat-transferable material than the retaining material.

2. The temperature sensor according to claim 1, wherein the heat insulating member in the heat insulating section is arranged in a state fixed to the wire member at a position near the temperature sensor element.

3. The temperature sensor according to claim 1, wherein the heat insulating member is made of foam polystyrene or a phenol resin.

4. The temperature sensor according to claims 1, wherein the heat insulating section includes gas kept between the heat insulating member and the temperature sensor element.

5. A position detection device comprising:
position detection means configured to detect a position of a detection object; and
temperature sensing means configured to sense an ambient temperature around the detection object,
wherein the temperature sensing means includes the temperature sensor according to claims 1.
